(19) United States
(12) Patent Application Publication
(10) Pub. No.: US 2004/0182995 A1
(43) Pub. Date: Sep. 23, 2004

(54) Method for the operation of a monitoring device and a monitoring device

(76) Inventor: Ingolf Braune, Gundelfingen (DE)

Correspondence Address: HARNESS, DICKEY & PIERCE, P.L.C., P.O. BOX 828, BLOOMFIELD HILLS, MI, 48303, US

(21) Appl. No.: 10/652,886

(22) Filed: Aug. 29, 2003

(30) Foreign Application Priority Data
Sep. 2, 2002 (DE) 102 40 438.0

(51) Int. Cl. H01J 40/14; G06M 7/00

(52) U.S. Cl. 250/221

(57) ABSTRACT

The invention relates to a method for the operation of a monitoring device in which a pre-determined monitored zone is monitored by means of at least one optoelectronic sensor, safety radiation detectable by means of the sensor is transmitted into the monitored zone by means of at least one radiation source and an operating zone coinciding at least partly with the monitored zone is illuminated by means of a lighting device by means of illumination radiation visible to the human eye, wherein the radiation source and the lighting device are operated coordinated with one another such that the safety radiation and the illumination radiation differ from one another at least with respect to a radiation parameter open to a differentiated evaluation. The invention moreover relates to a monitoring device.

The invention relates to a method for the operation of a monitoring device in which a pre-determined monitored zone is monitored by means of at least one optoelectronic sensor, safety radiation detectable by means of the sensor is transmitted into the monitored zone by means of at least one radiation source and an operating zone coinciding at least partly with the monitored zone is illuminated by means of a lighting device by means of illumination radiation visible to the human eye.

The invention further relates to a monitoring device having at least one optoelectronic sensor for the monitoring of a pre-determined monitored zone, at least one radiation source for the transmission into the monitored zone of safety radiation detectable by means of the sensor and a lighting device for the illumination of an operating zone coinciding at least partly with the monitored zone by means of illumination radiation visible to the human eye.

The working conditions applying at commercial workplaces must satisfy a plurality of legal provisions. These include safety-relevant provisions and the provisions of labor law. Moreover, the working conditions must be optimum with respect to the respective work process. The lighting of workplaces has particular importance. A sufficient illumination of the workplace is not only required by provisions of labor law, but is also indispensable for an optimum running of the respective work processes.

Labor safety also plays a central role at many workplaces. When the work processes running at the workplace, which involve dealing with machinery or others, represent a potential hazard for persons present at the workplace, a monitoring of the workplace increasingly takes place by means of optoelectronic monitoring devices which monitor the workplace and the work processes running there and e.g. stop a machine as soon as hazardous situations or situations representing a potential hazard occur which satisfy specific pre-determined conditions and which are recognized as such by the monitoring device.

Such optoelectronic monitoring devices require information from the operating zone to be monitored which is obtained in that the respective monitored zone has electromagnetic radiation applied to in a specific wavelength range and in that the radiation reflected from the monitored zone or the electromagnetic radiation passing through the monitored zone is examines by means of an optoelectronic detection device such as a camera system for the presence of the aforementioned conditions.

This means that not only means for the illumination of the operating zone, but also means for the transmission of electromagnetic radiation—also termed safety radiation in the following—into a monitored zone coinciding at least in part with the operating zone are required at workplaces, with the safety radiation and the respective optoelectronic detection device having to be matched to one another.

Reference is made to the German patent application 101 43 504.5 (attorney's reference: S 7828; LS 8/01) not yet published at the time of application of the present invention as an example for a monitoring device of the aforementioned kind.

To be able to satisfy the demands on the workplaces presented above, a comparatively high effort is required to achieve optimum lighting and simultaneously to satisfy a high safety standard, with a general problem being present in that the electromagnetic radiation which is used for the illumination of the workplace, and which is also termed external light from the viewpoint of the monitoring device, represents a potential source of interference for the optoelectronic detection device of the monitoring device and it is therefore necessary to reconcile all demands on the workplace.

It is therefore the object of the invention to provide a possibility of simultaneously providing optimum illumination at a workplace in a manner which is as simple as possible and nevertheless reliable, on the one hand, and of providing a secure and reliable monitoring, on the other hand, such that the illumination can take place where possible without interference by the measures taken for the monitoring and vice versa.

This object is satisfied, on the one hand, by the features of the independent method claim and in particular in that, starting from the initially named method for the operation of a monitoring device, the radiation source and the lighting device are operated in a manner matched to one another such that the safety radiation and the illumination radiation differ from one another at least with respect to a radiation parameter open to a differentiated evaluation.

In accordance with the invention, the selection of the illumination radiation or lighting radiation, which is also simply termed “light” in the following, and of the safety radiation does not only take place with respect to optimum satisfaction of the respectively separate function, i.e. of the safety radiation, on the one hand, and of the lighting function, on the other hand, but the safety radiation and the light used for illumination purposes are directly coordinated to one another such that they differ from one another in a manner which permits an evaluation of the safety radiation at least largely not interfered with by light.

In the following, a plurality of embodiments for specific realizations of this idea in accordance with the invention will be explained. The term “radiation parameter” in the sense of the present invention must therefore be given a wide interpretation and can generally relate to any aspect with respect to which the safety radiation, on the one hand, and the illumination radiation, on the other hand, differ from one another, with the aspect to be distinguished also being able to relate to the production, to the detection and to the time behavior of the respective radiation. A “differentiated” evaluation is to be understood as one which can utilize the difference between the illumination radiation and the safety radiation and which permits a direct evaluation of the safety radiation, i.e. which allows a clear separation between the lighting path, on the one hand, and the monitoring path, on the other hand, at least with respect to the radiation evaluation.

In accordance with an embodiment of the invention, provision is made for a distinguishing radiation parameter to be the transmission time of the radiation and for the safety radiation and the illumination radiation to be transmitted at different times.

It is thus possible, for example, to transmit the safety radiation and the illumination radiation alternately. It is possible to work in this process so to speak with mutually matched scanning relationships of the safety radiation, on the one hand, and of the lighting, on the other hand, with the one kind of radiation being transmitted in each case in breaks of the other kind of radiation. The one kind of radiation can, so to speak, form the complement to the other kind of radiation.

The mentioned “transmission breaks” can be such time intervals in which the intensity of the respective radiation is zero or in which the respective radiation admittedly is still present, but has a relative intensity minimum.

In a particularly preferred practical embodiment of the invention, provision is made for the intensity of the illumination radiation to be varied in accordance with the amplitude of the alternating voltage of an existing power supply network and for the detection of the safety radiation by means of the sensor to take place when the supply voltage for the lighting device is approximately zero.

The time behavior of the mains voltage can hereby be used for the purpose of transmitting the safety radiation during the breaks caused by the mains or during intensity minima of the light in order to carry out a monitoring unimpaired by the light in this manner.

The safety radiation is in particular transmitted in pulses and, due to the high repeating frequency of the safety radiation impulses, a quasi-continuous monitoring of the operating zone takes place, so to speak, which satisfies all safety demands occurring in practice.

It is furthermore preferred for the radiation detection taking place by means of the sensor and/or for the evaluation of the safety radiation detected by means of the sensor only to take place from time to time. The radiation detection or the evaluation of the detected safety radiation can in particular be synchronized with the time behavior of the transmission of the safety radiation. It can hereby be achieved that the sensor and the subsequent evaluation device are only active when the transmission of the safety radiation is taking place.

In accordance with the invention, it is also possible for the safety radiation and the illumination radiation to be transmitted simultaneously, with in particular the safety radiation being transmitted without interruption.

An advantage of this procedure consists of the fact that the monitoring of the operating zone or of the monitored zone takes place continuously.

In accordance with a further preferred embodiment of the invention, provision is made for a distinguishing radiation parameter to be the wavelength of the respectively used radiation.

The sensor can be designed selectively such that it is only sensitive to the safety radiation and is not subject to interference by the simultaneously incident illumination radiation.

The wavelength range used for the safety radiation can, in accordance with the invention, be formed either relatively wide or by a comparatively narrow wavelength band. In an embodiment, it is proposed that the wavelength range for the safety radiation lies above 800 nm. It is furthermore possible but not absolutely necessary, for the safety radiation to lie in the wavelength range visible to the human eye.

The differentiation by wavelength can take place by means of appropriately formed radiation sources. Alternatively or additionally, it is also possible in accordance with the invention to filter a wavelength range out of the illumination radiation and to provide a wavelength or a wavelength range for the safety radiation which lies inside the range filtered out or vice versa. An advantageous separation of the illumination path, on the one hand, and of the monitoring path, on the other hand, can take place in this manner.

In dependence on the respective application, it can be preferred for the wavelengths of the safety radiation and of the illumination radiation or for the filtered out wavelength range to be selected in dependence on the reflection behavior of the objects present or expected in the monitored zone. An optimum adaptation of the lighting and of the monitoring to the respective work process can hereby be realized.

A further possibility for the separation or distinguishing between the safety radiation and the light consists of providing different polarization properties for the kinds of radiation. If, for example, polarized light is used for the illumination radiation, the polarized illumination radiation can be reliably masked by using a correspondingly oriented polarization filter in the beam path of the safety radiation.

The object underlying the invention is moreover satisfied by the features of the independent apparatus claim and in particular in that, starting from the initially named monitoring device, the radiation source and the lighting device can be operated coordinated with one another such that the safety radiation and the illumination radiation differ from one another at least with respect to a radiation parameter open to a differentiated evaluation.

In a particularly preferred practical embodiment, the radiation source for the safety radiation is integrated into the lighting device.

Only one single total system, which is to be installed at the respective workplace, is hereby advantageously needed. The equipping of workplaces can hereby be carried out substantially more simply and thus more cost favorably.

The lighting device can be a workplace lighting serving directly only for the illumination of one or more workplaces or a so-called general lighting with which not only one or more workplaces can be illuminated, but also their environment.

The radiation source for the safety radiation can furthermore be a component of the lighting device. The radiation source can in particular be identical to a light source of the lighting device. In this case, a separation of the lighting path from the monitoring path can be achieved, for example, by the use of suitable filter devices.

Further preferred embodiments of the invention are recited in the dependent claims, in the description and in the drawing.

The invention will be described in the following purely by way of example with reference to the drawing. There are shown:

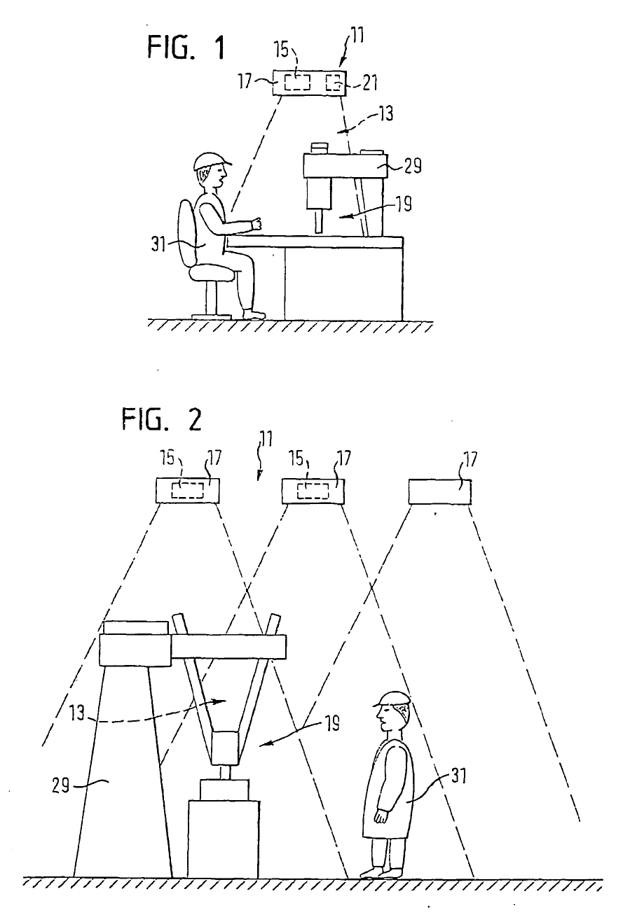

FIG. 1 purely schematically, a workplace with a single lighting device into which a radiation source for safety radiation is integrated;

FIG. 2 purely schematically, a further workplace in whose region a plurality of lighting devices are arranged of which only some are provided with a radiation source for safety radiation; and

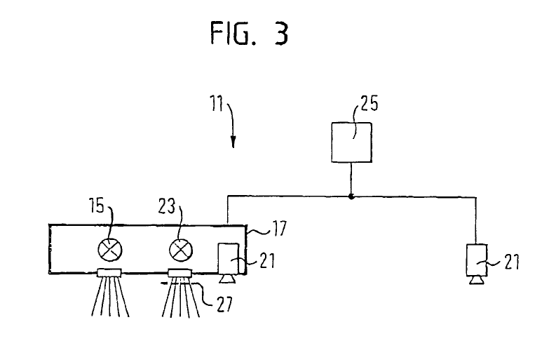

FIG. 3 purely schematically, an embodiment for a monitoring device in accordance with the invention.

FIG. 1 shows a workplace having a machine 29 which is arranged in an operating zone 19, which is operated by a person 31 or at which a person 31 must be present during the work process.

The monitoring device 11 in accordance with the invention includes a lighting device 17 having one or more light sources for the illumination of the operating zone 19 as well as a radiation source 15 which is integrated into the lighting device 17. The radiation source 15 transmits safety radiation at a pre-determined wavelength and/or at a pre-determined wavelength range into a monitored zone 13 which lies inside the operating zone 19 illuminated by means of the lighting device 17.

Safety radiation reflected from the monitored zone 13 is detected by means of a sensor 21, e.g. in the form of a camera, likewise integrated into the lighting device 17 and is examined for the presence of specific conditions such as is described in the introductory part of the present application.

In FIG. 2 a workplace is shown in which in turn a person 31 must again be present at a machine 29. The illumination of the operating region 19, on the one hand, and of its environment, on the other hand, takes place by means of a plurality of lighting devices 17. Those lighting devices 17, which provide the illumination of the operating zone 19, are moreover each provided with a radiation source 15 for the transmission of safety radiation serving for a security monitoring of the workplace.

FIG. 2 thus shows an example for a networked lighting and security system in which not every lighting device 17 is fitted with a sensor for the detection of safety radiation.

In all embodiments of the invention, the monitored zone 13 can be parameterizable, whereby a specific part of the operating zone 19 can directly be selected for the security-relevant monitoring. The monitored zone 13 and the operating zone 19 can lie completely within one another or overlap one another.

The parameterization preferably takes place by means of a control and evaluation device which is not shown in FIGS. 1 and 2, and which is connected at least to the radiation sources 15 for the safety radiation and to the sensors 21 (not shown in FIG. 2) of the monitoring device 11.

Provision can be made, for example, in the application shown in FIG. 2 for the monitored zone 13 to be formed by that part of the operating zone 19 in which the individual monitored zones of the two lighting devices 17 each provided with a radiation source 15 for the safety radiation overlap one another.

FIG. 3 illustrates purely schematically a further embodiment of a monitoring device 11 in accordance with the invention in which a radiation source 15 for the safety radiation, a light source 23 for the light serving for the illumination of an operating zone and a camera 21 serving as an optoelectronic detection device for the safety radiation are integrated into a lighting device 17.

A further camera 21 is arranged spatially separately from the lighting device 17 and can satisfy more complex monitoring tasks together with the camera 21 integrated into the lighting device 17 than is possible with a single camera 21.

The lighting device 17 and the external camera 21 are connected to a common control and evaluation device 25 with which all components of the monitoring device 11 in accordance with the invention, and in particular the production, the detection and the evaluation of the safety radiation, are controlled.

In FIG. 3, a filter device 27 arranged in front of the light source 23 is moreover indicated with which a pre-determined wavelength range is filtered out of the radiation emitted by the light source 23. The safety radiation emitted by the radiation source 15 and detectable by the cameras 21 lies within this wavelength range, with the cameras 21 or the following evaluation units each being designed such that wavelengths lying outside the filtered out region in the monitoring path are unproblematic or do not play any role at all, whereby a reliable separation of the lighting path, on the one hand, and of the monitoring path, on the other hand, is provided.

Generally, the possibilities described in the introductory part of the application for a differentiated evaluation of the information on radiation transported over the monitored zone 13, i.e. for a reliable separation of the lighting path from the monitoring path, can be used in connection with all embodiments described above.

Furthermore, generally a plurality of possibilities for the separation of illumination and monitoring can be combined with one another in an embodiment, i.e. the safety radiation and the illumination radiation can differ from one another simultaneously with respect to a plurality of radiation parameters.

### Reference Numeral List

11 monitoring device

13 monitored zone

15 radiation source

17 lighting device

19 operating zone

21 sensor, camera

23 light source

25 control and evaluation device

27 filter

29 machine

31 person

1. A method for the operation of a monitoring device (11), in which
a pre-determined monitored zone (13) is monitored by means of at least one optoelectronic sensor (21);
safety radiation detectable by means of the sensor (21) is transmitted into the monitored zone (13) by means of at least one radiation source (15); and
an operating zone (19) coinciding at least partly with the monitored zone (13) is illuminated by means of a lighting device (17) by means of illumination radiation visible to the human eye,
wherein the radiation source (15) and the lighting device (17) are operated coordinated with one another such that the safety radiation and the illumination radiation differ from one another at least with respect to a radiation parameter open to a differentiated evaluation.

2. A method in accordance with claim 1, characterized in that, the transmission time of the radiation is a distinguishing radiation parameter and the safety radiation and the illumination radiation are transmitted at different times.

3. A method in accordance with claim 1 or claim 2, characterized in that the safety radiation and the illumination radiation are transmitted alternately.

4. A method in accordance with any one of the preceding claims, characterized in that the intensity or the time development of the intensity of the radiation is a distinguishing radiation parameter.

5. A method in accordance with any one of the preceding claims, characterized in that the safety radiation is transmitted in each case in transmission breaks or during relative intensity minima of the illumination radiation or vice versa.

6. A method in accordance with any one of the preceding claims, characterized in that the intensity of the illumination radiation is varied in accordance with the amplitude of the alternating voltage of an existing power supply network and the detection of the safety radiation takes place by means of the sensor (21) when the supply voltage for the lighting device (17) is approximately zero.

7. A method in accordance with any one of the preceding claims, characterized in that the radiation detection taking place by means of the sensor (21) and/or the evaluation of the safety radiation detected by means of the sensor (21) only take or takes place from time to time.

8. A method in accordance with any one of the preceding claims, characterized in that the radiation detection taking place by means of the sensor (21) takes place in transmission breaks or during relative intensity minima of the illumination radiation.

9. A method in accordance with any one of the preceding claims, characterized in that the safety radiation and the illumination radiation are transmitted simultaneously, with the safety radiation in particular being transmitted without interruption.

10. A method in accordance with any one of the preceding claims, characterized in that the wavelength of the respectively used radiation is a distinguishing radiation parameter.

11. A method in accordance with any one of the preceding claims, characterized in that a wavelength range is filtered out of the illumination radiation and the wavelength of the safety radiation lies within the filtered range, or vice versa.

12. A method in accordance with any one of the preceding claims, characterized in that the wavelengths of the safety radiation and of the illumination radiation or the filtered wavelength range are selected in dependence on the reflection behavior of the objects present or expected in the monitored zone.

13. A method in accordance with any one of the preceding claims, characterized in that the polarization property of the radiation is a distinguishing radiation parameter.

14. A monitoring device comprising
at least one optoelectronic sensor (21) for the monitoring of a pre-determined monitored zone (13);
at least one radiation source (15) for the transmission into the monitored zone (13) of safety radiation detectable by means of the sensor (21); and
a lighting device (17) for the illumination of an operating zone (19) coinciding at least partly with the monitored zone (13) by means of illumination radiation visible to the human eye,
wherein the radiation source (15) and the lighting device (17) are operable coordinated with one another such that the safety radiation and the illumination radiation differ from one another at least with respect to a radiation parameter open to a differentiated evaluation.

15. A monitoring device in accordance with claim 14, characterized in that the radiation source (15) and the lighting device (17) are operable matched to one another in time and the safety radiation and the illumination radiation can be transmitted at different times.

16. A monitoring device in accordance with claim 14 or claim 15, characterized in that the safety radiation and the illumination radiation can be transmitted alternately.

17. A monitoring device in accordance with any one of claims 14 to 16, characterized in that the safety radiation can be transmitted in transmission breaks or during relative intensity minima of the illumination radiation or vice versa.

18. A monitoring device in accordance with any one of claims 14 to 17, characterized in that the radiation detection taking place by means of the sensor (21) can be interrupted from time to time and can be matched to the time development of the intensity of the illumination radiation.

19. A monitoring device in accordance with any one of claims 14 to 18, characterized in that the radiation detection taking place by means of the sensor (21) can be carried out in each case in transmission breaks or during relative intensity minima of the illumination radiation.

20. A monitoring device in accordance with any one of claims 14 to 19, characterized in that the safety radiation and the illumination radiation can be transmitted simultaneously.

21. A monitoring device in accordance with any one of claims 14 to 20, characterized in that different wavelengths are provided for the safety radiation detected by means of the sensor (21) and for the illumination radiation.

22. A monitoring device in accordance with any one of claims 14 to 21, characterized in that a filter (27) is arranged in the beam path of the illumination radiation with which a wavelength range can be filtered out in which the wavelength of the safety radiation lies, or vice versa.

23. A monitoring device in accordance with any one of claims 14 to 22, characterized in that different polarization properties are provided for the safety radiation detected by means of the sensor (21) and for the illumination radiation.

24. A monitoring device in accordance with any one of claims 14 to 23, characterized in that the radiation source (15) for the safety radiation is integrated into the lighting device (17), in particular into a workplace lighting or into a general lighting.

25. A monitoring device in accordance with any one of claims 14 to 24, characterized in that the radiation source (15) for the safety radiation is a component of the lighting device (17) and is in particular identical to a light source (23) of the lighting device (17).

26. A monitoring device in accordance with any one of claims 14 to 25, characterized in that it is operable in accordance with a method in accordance with any one of claims 1 to 13.
